(19) United States
(12) Patent Application Publication
(10) Pub. No.: US 2011/0052394 A1
(43) Pub. Date: Mar. 3, 2011

(54) CONICAL REVOLUTION MECHANISM

(75) Inventor: Richard KALHOFER, North Kingstown, RI (US)

(73) Assignee: International Products Group Corp, North Kingstown, RI (US)

(21) Appl. No.: 12/767,834

(22) Filed: Apr. 27, 2010

Related U.S. Application Data
(60) Provisional application No. 61/239,027, filed on Sep. 1, 2009.

(51) Int. Cl. F04D 29/34; H02K 7/12

(52) U.S. Cl. 416/100; 310/40.5

(57) ABSTRACT

Disclosed is a rotary fan having a fan blade, a stationary guard surrounding the fan blade, a stationary motor housing rigidly affixed to the stationary guard, and a revolution mechanism. The revolution mechanism includes a rotary motor revolvably affixed to the motor housing at a universal pivot, the rotary motor having a rotating shaft engage the fan blade such that rotation of the rotating shaft causes rotation of the fan blade, and such that rotation of the fan blade causes an airflow. A revolution motor is rigidly affixed to the motor housing, and one of a link and a disk is rotated by the revolution motor and has an eccentric pivot rotationally engaging the rotary motor and configured to convert rotation of the revolution motor to conical revolution of the rotary motor relative to the motor housing about the universal pivot, such that the fan blade and the airflow revolve in a conical path.

### RELATED APPLICATION

This application is a Continuation of and claims the benefit of pending U.S. Provisional Application Ser. No. 61/239,027, filed Sep. 1, 2009, the entire teachings of which are incorporated herein by reference.

### FIELD OF THE INVENTION

The present invention is related to motorized appliances, such as, but not limited to rotary fans, fan-forced heaters, fan-forced humidifiers, and fan-forced air cleaners. More specifically, the invention may be practiced in a conical revolution mechanism for such appliances, to revolve the motor in a conical pattern, such as for causing the airflow of a rotary fan to revolve in a conical pattern without movement of the fan's external components.

### BACKGROUND

An unchanging airflow directed at a person from a fan can be overbearing, even on the hottest days. A fan which does not provide any automatic airflow redirection causes air movement in only a small area of a room, thereby leaving the remainder of the room effectively unserviced. Such air flow tends to be laminar, with all air flowing unnaturally in the same direction.

The benefits of continuously altering the airflow direction from household fans are well known. The feeling one gets when airflow is altered or pulsed is found to be soothing and more refreshing. As airflow is continuously redirected around the room, a more natural turbulence is created which cools all parts of the body, not just those parts facing the fan. The entirety of the room receives the benefit of disturbed air, and no one person in the room is overly exposed to a constant and relentless wind.

As such, many fans are equipped with mechanisms for moving the fan head in a back and forth pattern, generically referred to as “oscillation”, and such fans generically being referred to as “oscillating fans”.

U.S. Pat. No. 2,618,434 teaches such a mechanism which causes the fan head to move back and forth on a horizontal plane over a given angle, thereby broadcasting airflow over that angle rather than in a constant straight line. As the fan head swings towards one side, people on that side of the room will momentarily feel strong airflow while people on the other side feel only gentle turbulence, then the fan will automatically swing towards the other side, and people on that other side of the room will momentarily feel the strong airflow while the people on the first side feel only the gentle turbulence. Such is found to be refreshing and invigorating and not relentless or overbearing.

Because heat rises, air temperature in a room tends to be hotter towards the ceiling and cooler towards the floor. It is desire-able to disturb such stratification of the air and bring the cooler air up from the floor in the summer time and to bring the warmer air down from the ceiling in the wintertime. An obvious benefit lies in the ability to incorporate such a function into a fan's oscillating mechanism.

U.S. Pat. No. 5,556,256 teaches such a mechanism which causes the fan head to revolve around in a conical pattern over a given conical angle, thereby broadcasting airflow over that conical angle rather than in a constant straight line or a horizontal angle. As the fan head revolves towards one side, people on that side of the room will momentarily feel strong airflow while people on the other side feel only gentle turbulence, then the fan will automatically revolve upwards towards the ceiling, and stale air collecting at the ceiling will be disturbed and mixed down into the room, then the fan will automatically revolve towards the other side, and people on that other side of the room will momentarily feel the strong airflow while the people on the first side feel only the gentle turbulence, and then the fan will automatically revolve downwards towards the floor, and cool air collecting at the floor will be disturbed and mixed up into the room. Such is found to be refreshing and invigorating and not relentless or overbearing, and to also create a more homogenous level of turbulence, oxygen, and temperature through the room.

Such mechanisms as are disclosed in U.S. Pat. No. 2,618,434 and U.S. Pat. No. 5,556,256 cause the entire fan head to move with the airflow. Such an inadvertent byproduct of the oscillation mechanism poses several problems. The first of those problems is safety. Any moving external component of an appliance can be an attractive hazard to children and pets and can accidentally pinch or injure or knock things over. The second of those problems is spacial. Room must be allowed beyond periphery of the fan to avoid the fan in all of its possible positions and shapes. Appliances with moving parts inherently take up more valuable space than do unmoving appliances. The third of those problems is power consumption. It takes power to move the fan's entire head, which power could better be spend rotating the fan's motor to cause airflow.

US Publication 2008/0304969 teaches a mechanism which causes just the motor and blade of a fan to revolve around in a conical pattern, thereby broadcasting airflow over that conical angle without the need to move the entire fan head. An independent revolution motor communicates between the fan's stationary housing and its main motor to cause the main motor to rotate in a conical pattern relative to the stationary housing. The fan blade moves with the main motor, causing the resulting airflow to revolve in the same conical pattern. The fans' blade guard is rigidly affixed to the stationary fan housing, and is thereby stationary.

While the disclosure of US Publication 2008/0304969 attempts provide a conical airflow and attempts to address some of the afforested drawbacks of fans such that disclosed in U.S. Pat. No. 5,556,256, it suffers from a relationship between the main motor, revolution motor, and stationary housing, which renders it difficult to manufacture, unsafe, and unreliable. Specifically, the revolution motor is affixed directly to and against the main motor. As such, the subassembly of the main motor, revolution motor, and revolution link must be preassembled and inserted blindly into the fan housing.

Firstly, while not shown in the disclosure, wiring connected to the revolution motor is virtually impossible to contain in a manner that assures it will not be contacted by the rotating revolution link. Such repetitive contact will quickly cut into and expose the live wiring and create a fire and shock hazard.

Secondly, with the revolution motor affixed to and revolving with the main motor, the wiring to the revolution motor undergoes constant motion and flexation. Such repetitive motion and flexation will eventually fatigue the wiring and cause fraying which will expose the live wiring and create a fire and shock hazard.

Thirdly, the main motor and the revolution motor are both inherently hot during operation. Air circulation around the motors is required to maintain the motors at a safe operating temperature. Direct abutting contact between the two motors during operation increases the temperature of both and denies cooling airflow around much or each motor. In order to prevent overheating, power must be reduced, thereby decreasing the airflow output of the fan.

Fourthly, the housing of the main and revoluting motors are preferably made of metal, and it is found that in some cases direct metal to metal contact of such inductive components causes destructive electromagnetic effects and objectionable noise.

There exists the need for a better mechanism to move the motor of an appliance in a conical pattern, such as for causing the airflow of a rotary fan to move in a conical pattern, and such is an object of the invention. There exists the need to provide such a conical airflow from a rotary fan in which the external components of the fan are stationary, and such is an object of the invention. There exists the need to provide such an airflow from a rotary fan which is safe and reliable, and such is an object of the invention. There exists the need to provide such an airflow from a rotary fan which is powerful, and such is an object of the invention. There exists the need to provide such an airflow from a rotary fan which is quieter and free of destructive electromagnetic effects, and such is an object of the invention. There exists the need to provide such an airflow from a rotary fan which is more easily manufacturable, and such is an object of the invention. There exists the need to provide such an airflow from a rotary fan without movement of the fan's external components, and such is an object of the invention.

Further needs and objects exist are addressed by the present invention, as may become apparent upon review of the included disclosure of exemplary embodiments thereof.

### SUMMARY OF THE INVENTION

The invention may be practiced in a rotary fan as a mechanism for causing the airflow to move in a conical pattern without movement of the fan's external components.

The mechanism is more reliable, safer, and more powerful than prior art fans such as that depicted in US Publication 2008/0304969, at least because it employs an revolution motor affixed directly to its rear motor housing and isolated thermally and electrically from its main motor. The mechanism is more easily manufactured, more reliable, and safer than prior art fans such as that depicted in US Publication 2008/0304969, at least because it allows the revolution motor to be affixed to the rear motor housing prior to installation of the main motor so that the revolution motor's associated wiring can be securely contained in avoidance of the paths of the rotating revolution link and revolving main.

The invention may be practiced in a revolution mechanism including a motor housing, a rotary motor revolvably affixed to the motor housing at a universal pivot, a revolution motor rigidly affixed to the motor housing, one of a link and a disk rotated by the revolution motor and having an eccentric pivot rotationally engaging the rotary motor and configured to convert rotation of the revolution motor to conical revolution of the rotary motor relative to the motor housing about the universal pivot. The revolution motor may include wiring, and the wiring may be rigidly affixed to the motor housing. The rotation of the one of a link and a disk may define a rotation path and the wiring may be restrained from the rotation path. The revolution of the rotary motor may defines a revolution path, and the wiring may be restrained from the revolution path. The wiring may be stationarily restrained to the motor housing.

The invention may also be practiced in a conical airflow revolution mechanism for a rotary fan including a fan blade, a motor housing, a rotary motor revolvably affixed to the motor housing at a universal pivot, the rotary motor having a rotating shaft engage the fan blade such that rotation of the rotating shaft causes rotation of the fan blade, and such that rotation of the fan blade causes an airflow, a revolution motor rigidly affixed to the motor housing, one of a link and a disk rotated by the revolution motor and having an eccentric pivot rotationally engaging the rotary motor and configured to convert rotation of the revolution motor to conical revolution of the rotary motor relative to the motor housing about the universal pivot, such that fan blade and the airflow revolve in a conical path. The revolution motor may include wiring, and the wiring may be rigidly affixed to the motor housing. The rotation of the one of a link and a disk may define a rotation path and the wiring may be restrained from the rotation path. The revolution of the rotary motor may defines a revolution path, and the wiring may be restrained from the revolution path. The wiring may be stationarily restrained to the motor housing.

The invention may also be practiced in a rotary fan including a fan blade, a stationary guard surrounding the fan blade, a stationary motor housing rigidly affixed to the stationary guard, a revolution mechanism including, a rotary motor revolvably affixed to the motor housing at a universal pivot, the rotary motor having a rotating shaft engage the fan blade such that rotation of the rotating shaft causes rotation of the fan blade, and such that rotation of the fan blade causes an airflow, a revolution motor rigidly affixed to the motor housing, and one of a link and a disk rotated by the revolution motor and having an eccentric pivot rotationally engaging the rotary motor and configured to convert rotation of the revolution motor to conical revolution of the rotary motor relative to the motor housing about the universal pivot, such that the fan blade and the airflow revolve in a conical path. The revolution motor may include wiring, and the wiring may be rigidly affixed to the motor housing. The rotation of the one of a link and a disk may define a rotation path and the wiring may be restrained from the rotation path. The revolution of the rotary motor may defines a revolution path, and the wiring may be restrained from the revolution path. The wiring may be stationarily restrained to the motor housing.

Further features and aspects of the invention are disclosed with more specificity in the Detailed Description and accompanying drawings of an exemplary embodiment provided herein.

### BRIEF DESCRIPTION OF THE DRAWINGS

Many aspects of the invention can be better understood with reference to the included Drawings showing exemplary embodiments for practicing the invention which correspond to the accompanying Detailed Description. The components in the Drawings are not necessarily to scale, emphasis instead being placed upon clearly illustrating the principles of the invention. Moreover, like reference numerals in the Drawings designate corresponding parts throughout the several views.

FIG. 1 is a perspective view of a rotary fan according to a first exemplary embodiment for practicing the invention, having its front guard exploded there-from and showing the fan blade aiming downwardly;

FIG. 2 is a perspective view of the rotary fan of FIG. 1, having its front guard exploded there-from and showing the fan blade aiming upwardly;

FIGS. 3A through 3D are a series of sequential views showing the conical revolution of the main motor of the rotary fan of FIG. 1;

FIG. 4 is close up view of the main motor, revolution motor, and revolution link of the rotary fan of FIG. 1;

FIG. 5 is close up view of the main motor, revolution motor, and eccentric revolution disk of a rotary fan according to a first exemplary embodiment for practicing the invention;

FIG. 6 is a cross-sectional view of the main motor, revolution motor, and eccentric revolution disk of the rotary fan of FIG. 5; and

FIG. 7 is a circuit drawing for energization of the fans of FIGS. 1 and 5.

### DETAILED DESCRIPTION OF AN EXEMPLARY EMBODIMENT

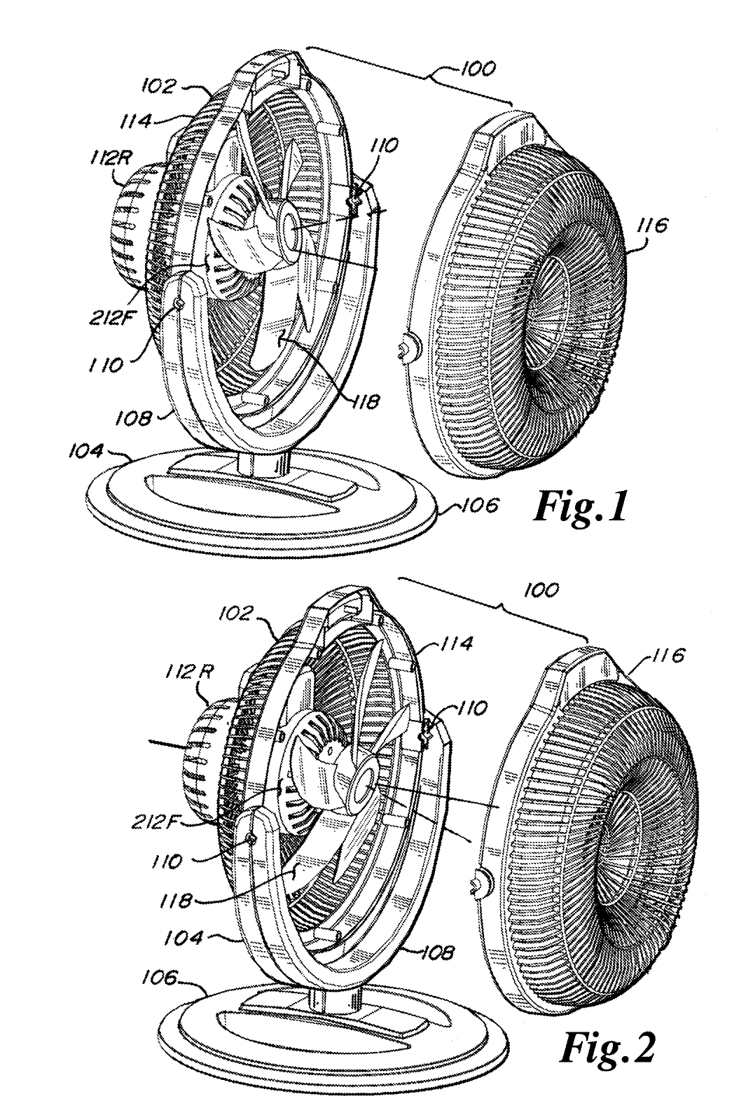

FIGS. 1 through 4 depict a rotary fan according to a first exemplary embodiment for practicing the invention.

Referring to FIGS. 1 and 2, fan 100 includes fan head 102 supported by fan stand 104. The stand includes base 106 and y-shaped yoke 108 which may be manually horizontally rotatable relative to the base. The yoke includes a pair of horizontally coaxial pivots 110.

The fan head includes motor housing 112, rear guard 114, and front guard 116. The fan head is affixed to the stand at pivots 110 such that the head is vertically pivotable relative to the stand. The motor housing is made up of front motor housing portion 112F and rear motor housing portion 112R

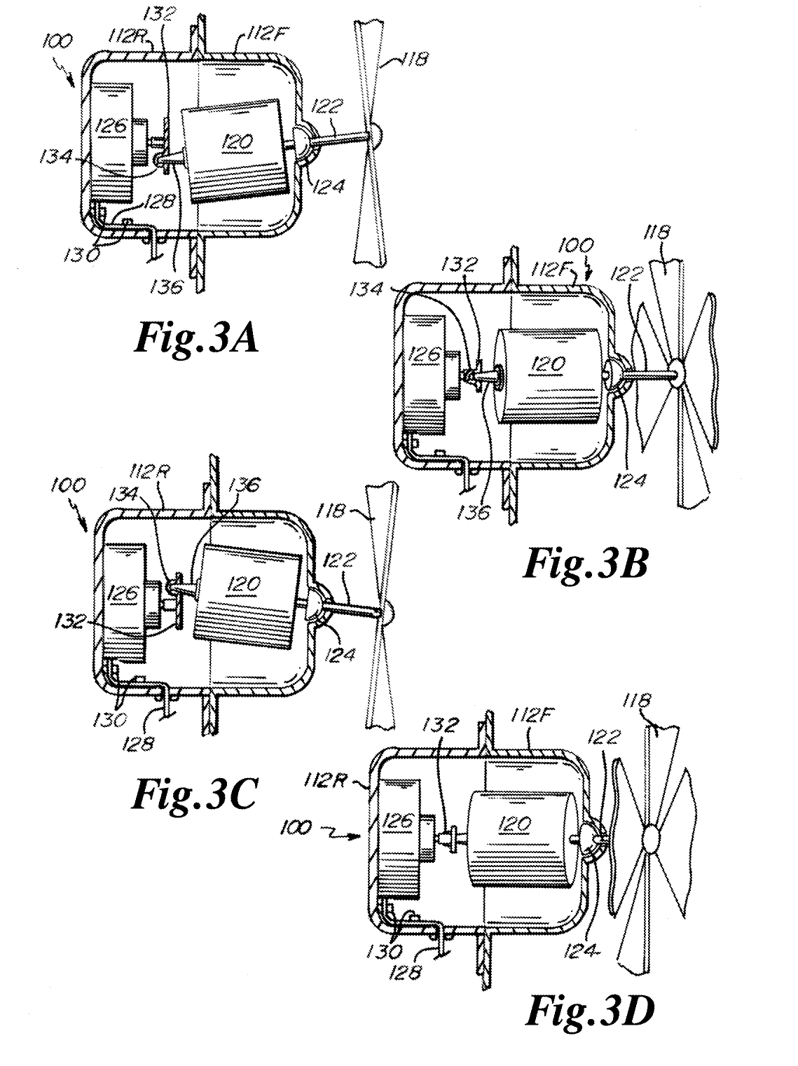

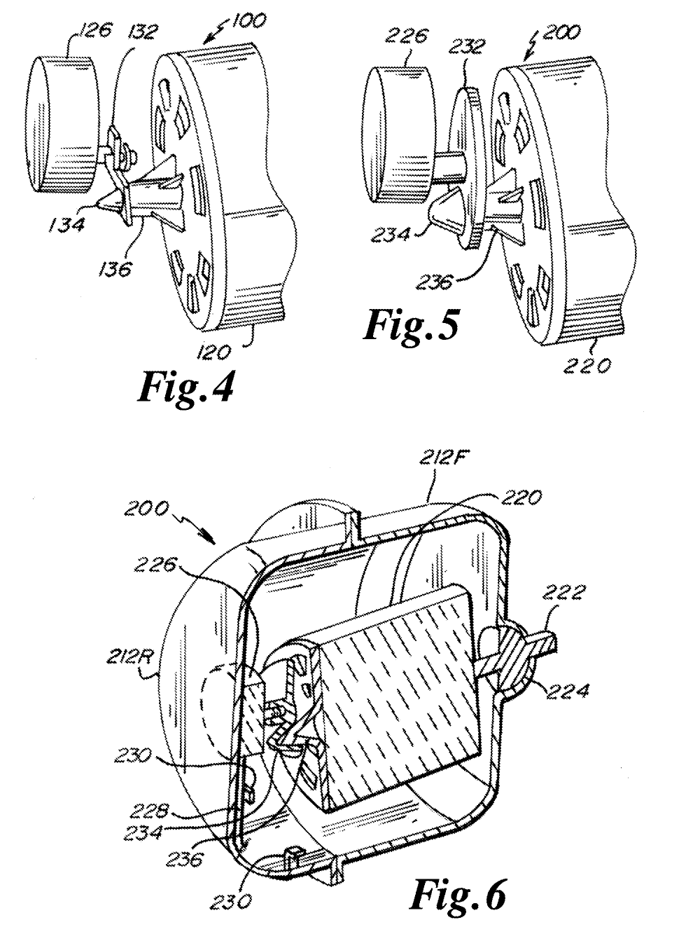

The head also includes fan blade 118 disposed within and between the front and rear guards. The fan blade is affixed directly and indirectly to several internal components which are seen in FIGS. 3A through 4, and will be described in view thereof.

Referring to FIGS. 3A through 3D, main motor 120 includes rotating shaft 122 to which fan blade 118 is affixed and with which the fan blade rotates when the motor is energized. Rotation of the fan blade results in generation of an airflow which is directed along the rotational axis of the main motor. The main motor is revolvably affixed to the front motor housing portion 112F of motor housing 112 at universal pivot 124, such that the orientation of the main motor, and this the direction of airflow from the fan blade, may be altered relative to the housing according to the positioning of the main motor.

Revolution motor 126 is rigidly affixed to the rear motor housing portion 112R of motor housing 112, and includes wiring 128 which is restrained to the rear motor housing portion by molded-in clips 130. The revolution motor is affixed to and, when energized, causes rotation of revolution link 132, which includes eccentric pivot 134. The eccentric pivot engages the main motor such that rotation of the link forces the main motor to move in a conical revolution pattern about the universal pivot, and relative to the motor housing, as is best appreciated by comparison of FIGS. 3A, 3B, 3C, and 3D. Such movement of the motor causes equivalent conical movement of the fan blade, and thus causes a conical pattern to the air flow caused by the fan blade.

FIG. 3A shows the state of the revolution motor, revolution link, main motor, and fan blade when the main motor is forced into its most upwardly directed point of its revolution, and the resulting airflow is directed upward. FIG. 3B shows the state of the revolution motor, revolution link, main motor, and fan blade when the main motor is forced into its most leftwardly directed point of its revolution, and the resulting airflow is directed leftward. FIG. 3C shows the state of the revolution motor, revolution link, main motor, and fan blade when the main motor is forced into its most downwardly directed point of its revolution, and the resulting airflow is directed downward. FIG. 3D shows the state of the revolution motor, revolution link, main motor, and fan blade when the main motor is forced into its most rightwardly directed point of its revolution, and the resulting airflow is directed rightward.

The revolution motor with the revolution link attached is initially affixed to the rear motor housing portion 112R, and its wiring is secured rigidly thereto by clips 130 prior to installation of the main motor. The eccentric pivot accepts a protrusion 136 extending from the rear of the main motor as the motor is inserted so that no fastening is required. As the main motor and link are moved, then impinge on a zone from which the wiring is restrained as a result of its affixation to the housing. This prevents the wiring from being injured be the link and main motor.

FIGS. 5 and 6 depict portions of a rotary fan 200 according to a second exemplary embodiment for practicing the invention, which is identical to the first embodiment except employing an eccentric revolution disk in place of the first embodiment's revolution link. Like numbering is used in FIGS. 5 and 6 for the second embodiment, except in 200 series, compared to the 100 series numbering used in for the first embodiment.

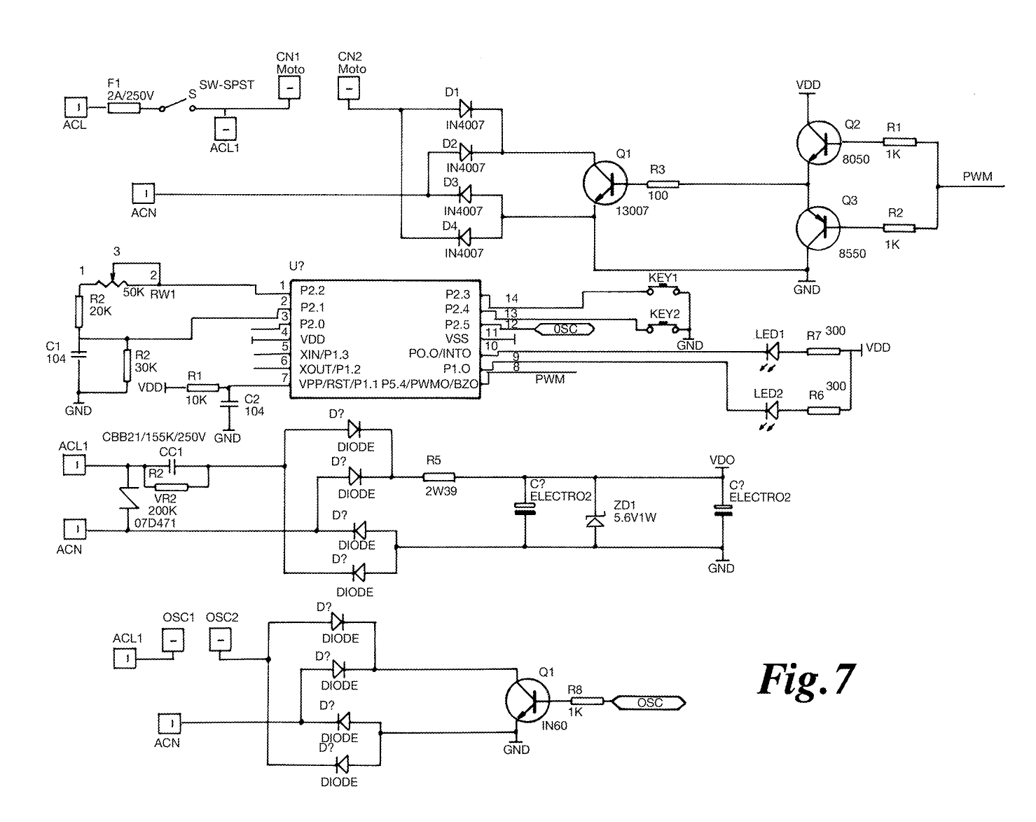

FIG. 7 shows a circuit diagram for energizing the main and revolution motors of either fan 100 or fan 200. Features of the variable speed control circuit include;
Electronic six speed control system—controls fan speed and oscillation for total room circulation,
Electronic variable speed control—Electronically controls fan speed range from maximum power to quiet operation for bedroom use,
Built in breeze mode function with variable speed control.

Various changes in form and detail may be made without departing from the spirit and scope of the invention, so the invention should therefore only be considered according to the following claims, including all equivalent interpretation to which they are entitled.

I claim:

1. A revolution mechanism comprising:
a motor housing;
a rotary motor revolvably affixed to the motor housing at a universal pivot;
a revolution motor rigidly affixed to the motor housing;
one of a link and a disk rotated by the revolution motor and having an eccentric pivot rotationally engaging the rotary motor and configured to convert rotation of the revolution motor to conical revolution of the rotary motor relative to the motor housing about the universal pivot.

2. The mechanism of claim 1 wherein the revolution motor comprises wiring, and the wiring is rigidly affixed to the motor housing.

3. The mechanism of claim 2 wherein the rotation of the one of a link and a disk defines a rotation path and wherein the wiring is restrained from the rotation path.

4. The mechanism of claim 2 wherein the revolution of the rotary motor defines a revolution path and wherein the wiring is restrained from the revolution path.

5. The mechanism of claim 4 wherein the rotation of the one of a link and a disk defines a rotation path and wherein the wiring is restrained from the rotation path.

6. The mechanism of claim 5 wherein the wiring is stationarily restrained to the motor housing.

7. A conical airflow revolution mechanism for a rotary fan comprising:
a fan blade;
a motor housing;
a rotary motor revolvably affixed to the motor housing at a universal pivot, the rotary motor having a rotating shaft engage the fan blade such that rotation of the rotating shaft causes rotation of the fan blade, and such that rotation of the fan blade causes an airflow;
a revolution motor rigidly affixed to the motor housing;
one of a link and a disk rotated by the revolution motor and having an eccentric pivot rotationally engaging the rotary motor and configured to convert rotation of the revolution motor to conical revolution of the rotary motor relative to the motor housing about the universal pivot, such that fan blade and the airflow revolve in a conical path.

8. The conical airflow revolution mechanism of claim 7 wherein the revolution motor comprises wiring, and the wiring is rigidly affixed to the motor housing.

9. The conical airflow revolution mechanism of claim 8 wherein the rotation of the one of a link and a disk defines a rotation path and wherein the wiring is restrained from the rotation path.

10. The conical airflow revolution mechanism of claim 8 wherein the revolution of the rotary motor defines a revolution path and wherein the wiring is restrained from the revolution path.

11. The conical airflow revolution mechanism of claim 10 wherein the rotation of the one of a link and a disk defines a rotation path and wherein the wiring is restrained from the rotation path.

12. The conical airflow revolution mechanism of claim 11 wherein the wiring is stationarily restrained to the motor housing.

13. A rotary fan comprising:
a fan blade;
a stationary guard surrounding the fan blade;
a stationary motor housing rigidly affixed to the stationary guard;
a revolution mechanism comprising;
a rotary motor revolvably affixed to the motor housing at a universal pivot, the rotary motor having a rotating shaft engage the fan blade such that rotation of the rotating shaft causes rotation of the fan blade, and such that rotation of the fan blade causes an airflow;
a revolution motor rigidly affixed to the motor housing; and
one of a link and a disk rotated by the revolution motor and having an eccentric pivot rotationally engaging the rotary motor and configured to convert rotation of the revolution motor to conical revolution of the rotary motor relative to the motor housing about the universal pivot, such that the fan blade and the airflow revolve in a conical path.

14. The rotary fan of claim 13 wherein the revolution motor comprises wiring, and the wiring is rigidly affixed to the motor housing.

15. The rotary fan of claim 14 wherein the rotation of the one of a link and a disk defines a rotation path and wherein the wiring is restrained from the rotation path.

16. The rotary fan of claim 14 wherein the revolution of the rotary motor defines a revolution path and wherein the wiring is restrained from the revolution path.

17. The rotary fan of claim 16 wherein the rotation of the one of a link and a disk defines a rotation path and wherein the wiring is restrained from the rotation path.

18. The rotary fan of claim 17 wherein the wiring is stationarily restrained to the motor housing.
